(19) United States
(12) Patent Application Publication
(10) Pub. No.: US 2026/0219437 A1
(43) Pub. Date: Jul. 30, 2026

(54) LIGHT GUIDE FOR A BACKLIGHT UNIT, BACKLIGHT UNIT AND DISPLAY DEVICE

(71) Applicants: CONTINENTAL AUTOMOTIVE TECHNOLOGIES GMBH, Hannover (DE); LEIA INC., Menlo Park, CA (US)

(72) Inventors: Christian JUNGE, Frankfurt am Main (DE); Andreas KOLLOCH, Frankfurt am Main (DE); Ming MA, Menlo Park, CA (US); Ilia PAVLOVETC, Menlo Park, CA (US)

(21) Appl. No.: 19/148,627

(22) PCT Filed: Feb. 28, 2023
(86) PCT No.: PCT/EP2023/055054

§ 371 Date: Jul. 16, 2025

Related U.S. Application Data
(60) Provisional application No. 63/439,355, filed on Jan. 17, 2023.

(51) Int. Cl. F21V 8/00

(52) U.S. Cl. CPC G02B 6/0045; G02B 6/0028

(57) ABSTRACT

The present invention is related to a light guide (3) for a backlight unit. The invention is further directed towards a backlight unit that comprises such a light guide (3) and to a display device that comprises such a backlight unit. The light guide (3) comprises at least one light incoupling section (30) having a first thickness (dₗᵢₛ), a light guiding section (32) having a second thickness (d_{lgs}) smaller than the first thickness (dₗᵢₛ), and at least one tapered light mixing section (31) connecting the at least one light incoupling section (30) and the light guiding section (32). The at least one light incoupling section (30) comprises an array of total internal reflection collimators (300). The light guiding section (32) has a top surface (320) and a bottom surface (321) and is configured to couple out light guided within the light guiding section (32) through the top surface (320).

The present invention is related to a light guide for a backlight unit. The invention is further directed towards a backlight unit that comprises such a light guide and to a display device that comprises such a backlight unit.

In modern motor vehicles, an increasing amount of information is provided for the driver or other vehicle occupants, which goes far beyond the display of the vehicle's condition. Conventional combination instruments are therefore increasingly being replaced by freely programmable, digital displays. Such displays often make use of a transmissive display panel, e.g. a liquid crystal display panel, in combination with a backlight unit.

Nowadays, display backlight units are mostly based on edge-lit light guides into which the light from several light-emitting diodes (LED) is coupled via a side face of the light guide. The light propagates in the light guide by total reflection and is coupled out again by special outcoupling structures on the surface of the light guide or by a special choice of the light guide geometry, such as a tapered light guide. To modify and improve efficiency, homogeneity, and angular emission characteristics of the light that is coupled out, additional components are often applied, like diffusor films, prism films, polarizer films, or special coatings.

U.S. Pat. No. 11,048,037 B2 discloses a backlight and a multiview display that employ a light guide having an angle-preserving scattering feature and a tapered collimator. The angle-preserving scattering feature is configured to scatter a portion of guided light out of the light guide as emitted light. The tapered collimator is configured to collimate light provided by a light source as collimated light and to communicate the collimated light to the light guide to be guided as the guided light.

US 2007/0081360 A1 discloses a display backlight assembly providing improved optical coupling between a solid-state light source and a display optical light guide. The assembly includes an optical coupler to couple the solid-state light source and display optical light guide together. In addition, the optical coupler may include a light mixing element for improved mixing of the multi-colored or mono-chromatic light produced by the solid-state light source.

US 2017/0285242 A1 discloses a liquid crystal display device that includes a light source that emits light having a predetermined color, a lens that concentrates the light emitted from the light source and causes the light to exit, a band-pass filter that transmits specific-band light having a specific-band wavelength in the light exiting from the lens, and a light guide plate disposed on a rear surface side of a display panel. The specific-band light transmitted through the band-pass filter is incident on a lateral surface of the light guide plate.

The typical emission characteristic of an edge-lit backlight system has a broad angular distribution. While this property is beneficial for many applications where the display needs to be readable from a wide angular range, in some applications the light emitted by a display should be limited to a small angular range. For instance, head-up displays or switchable privacy displays require a very narrow and well-defined angular emission. This narrow distribution cannot be achieved with current edge-lit configurations. As an alternative, direct-lit systems can be used, which illuminate the display with an array of light sources and some collimation optics. This configuration allows achieving narrow light distributions. However, to achieve an acceptable homogeneity, the required space for the illumination system is much larger compared to edge-lit systems.

It is an object of the present invention to provide a compact edge-lit backlight unit for a display device with a narrow angular light distribution, high efficiency, and homogeneous illumination.

This object is achieved by a light guide according to claim 1, by a backlight unit according to claim 13, and by a display device according to claim 14. The dependent claims include advantageous further developments and improvements of the present principles as described below.

According to a first aspect, a light guide for a backlight unit comprises:
at least one light incoupling section having a first thickness, the at least one light incoupling section comprising an array of total internal reflection collimators;
a light guiding section having a second thickness smaller than the first thickness, the light guiding section having a top surface and a bottom surface, wherein the light guiding section is configured to couple out light guided within the light guiding section through the top surface; and
at least one tapered light mixing section connecting the at least one light incoupling section and the light guiding section.

To create a narrow light distribution with an edge-lit light guide, it is necessary to precisely control the angular distribution of the light that is propagating in the light guide. For this purpose, the light needs to be collimated during incoupling. According to the invention, an array of total internal reflection (TIR) collimators is used. Such total internal reflection collimators are particularly advantageous, as they are able to collect the light emitted by light-emitting diodes with high efficiency and to restrict the collected light to a small angular range. The array of total internal reflection collimators is connected via a light mixing section to a light guiding section. For efficient outcoupling of the light, the light guiding section needs to have a small thickness to increase interaction of the light with the surfaces of the light guiding section. However, if the total internal reflection collimators were connected directly to the light guiding section, the small thickness would limit the diameter of the collimators. As a consequence, due to conservation of Étendue, it would not be possible to achieve a narrow angular light distribution. The Étendue is a physical quantity which, in simple terms, is determined by the angular distribution at each point of the light beam and its cross-sectional area. A conservation law states that the Étendue can only remain the same or increase when passing through an optical system. Therefore, according to one aspect of the invention, a larger thickness is used in the light incoupling section, thereby achieving a narrow light distribution. To connect the light incoupling section to the thinner light guiding section, the light mixing section is tapered and gradually reduces its thickness along the propagation to the light guiding section. This compression of the cross-section area will again, by conservation of Étendue, lead to an angular broadening of the light distribution. However, in this configuration, the broadening of the angles will appear only in one dimension, while the favorable collimation along the other dimension is preserved. The solution according to the invention thus allows achieving narrow light distributions with very high efficiency and good light mixing. The light guide may, for example, be manufactured by injection molding or by combining a light guide section made of glass with a light incoupling section and a light mixing section formed by injection molding. The light guide may also be fully made of glass.

In an advantageous embodiment, the bottom surface of the light guiding section comprises outcoupling structures, wherein the outcoupling structures have regions that are inclined relative to the bottom surface of the light guiding section and are configured to direct a fraction of the light guided within the light guiding section towards the top surface of the light guiding section. By adequate choice of the geometry of the outcoupling structures in the light guiding section, only a fraction of the broadened angular light distribution in the light guiding section is outcoupled. As a consequence, the resulting light distribution at a display panel that is illuminated using the light guide is still very narrow.

In an advantageous embodiment, a length and a tapering of the tapered light mixing section are designed such that in conjunction with the outcoupling structures the light coupled out of the light guiding section has a narrow angular distribution. By proper design of the tapered light mixing section and the outcoupling structures, the angular light distribution can be modified in a very controlled way.

In an advantageous embodiment, a density of the outcoupling structures along a propagation direction of the light guided within the light guiding section is designed such that the light coupled out of the light guiding section has an essentially constant brightness distribution over the whole length of the light guiding section. By increasing the density of the outcoupling structures along the propagation direction in the light guide, an essentially constant brightness distribution can be achieved. The increased density of the outcoupling structures compensates for the reduction of the available amount of light along the propagation direction.

In an advantageous embodiment, the light guide further comprises a diffuser film arranged on or above the top surface of the light guiding section. Such a diffuser film can be used, for example, to further improve the homogeneity and to modify the angular light distribution.

In an advantageous embodiment, the light guide further comprises a reflective coating arranged on the bottom surface of the light guiding section. In this way, light losses through the bottom surface are greatly reduced, which increases the efficiency of the system.

In an advantageous embodiment, the light guide further comprises a reflective polarizer arranged on or above the top surface of the light guiding section. The design without a tapered light guide section, i.e. the design where top surface and bottom surface of the light guiding section are arranged parallel to each other, allows implementing so-called polarization recycling. The reflective polarizer on or above the light guiding section reflects light with a polarization state that would otherwise be absorbed by the display panel that is illuminated using the light guide. With the help of a retardation film or birefringence, the polarization state of the reflected light can be transformed into the usable polarization state upon a retroreflection at the bottom surface of the light guiding section. To this end, the light guide advantageously further comprises a retardation film arranged between the top surface of the light guiding section and the reflective polarizer. Alternatively, the light guiding section may consist of a birefringent material. With both approaches, the efficiency of the system is increased.

In an advantageous embodiment, the outcoupling structures have regions that are parallel to the bottom surface of the light guiding section. In this way, the outcoupling structures maximize the reflection and preserve the direction of the recycled light.

In an advantageous embodiment, an end face of the light guiding section is designed to reflect light guided within the light guiding section that reaches the end face. The light reaching the end face is reflected and propagates back through the light guide. During its backpropagation, the reflected light is at least partially coupled out of the light guide as illumination light, which further increases the efficiency. The end face may be designed such that the reflection causes a change in the angle of propagation of the reflected light. For example, the end face may be inclined with respect to the propagation direction of the light guided within the light guiding section. In this way, another part of the angular light distribution is coupled out during the back propagation.

In an advantageous embodiment, light incoupling sections and tapered light mixing sections are arranged at two sides of the light guiding section. This solution has the advantage that light may be coupled into the light guiding section from two different sides, which further improves homogeneity of the light that is coupled out of the light guiding section.

Advantageously, a light guide according to the invention is used in a backlight unit for a display device. The backlight unit further comprises at least one array of light sources, which are configured to emit light towards the total internal reflection collimators of the light guide.

Advantageously, a backlight unit according to the invention is used in a display device, e.g., a display device for automotive applications. For example, the display device may be used in a head-up display or may be configured to provide a switchable privacy functionality. Of course, use of the backlight unit is not limited to these applications. The described solutions are useful for all kind of applications which require homogenous planar light sources with controllable angular emission characteristics.

In one embodiment, the display device further comprises a prism film configured to change a direction of illumination light originating from the backlight unit. This is particularly useful if the viewing direction is not perpendicular to a display panel of the display device, which may be the case if the display panel is inclined to avoid solar reflections. The prism film may be part of the backlight unit or a separate component of the display device.

Further features of the present invention will become apparent from the following description and the appended claims in conjunction with the figures.

### FIGURES

FIG. 1 shows a perspective view of a light guide according to the invention;

FIG. 2 shows a side view of the light guide of FIG. 1;

FIG. 3 shows a front view of a light incoupling section of the light guide of FIG. 1;

FIG. 4 illustrates light paths and outcoupling structures of the light guide of FIG. 1;

FIG. 5 shows a front view of a backlight unit according to a first embodiment, which uses a light guide according to the invention;

FIG. 6 shows a front view of a backlight unit according to a second embodiment, which uses a light guide according to the invention; and

FIG. 7 shows a cut through a display device comprising a backlight unit with a light guide according to the invention.

### DETAILED DESCRIPTION

The present description illustrates the principles of the present disclosure. It will thus be appreciated that those skilled in the art will be able to devise various arrangements that, although not explicitly described or shown herein, embody the principles of the disclosure.

All examples and conditional language recited herein are intended for educational purposes to aid the reader in understanding the principles of the disclosure and the concepts contributed by the inventor to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams presented herein represent conceptual views embodying the principles of the disclosure.

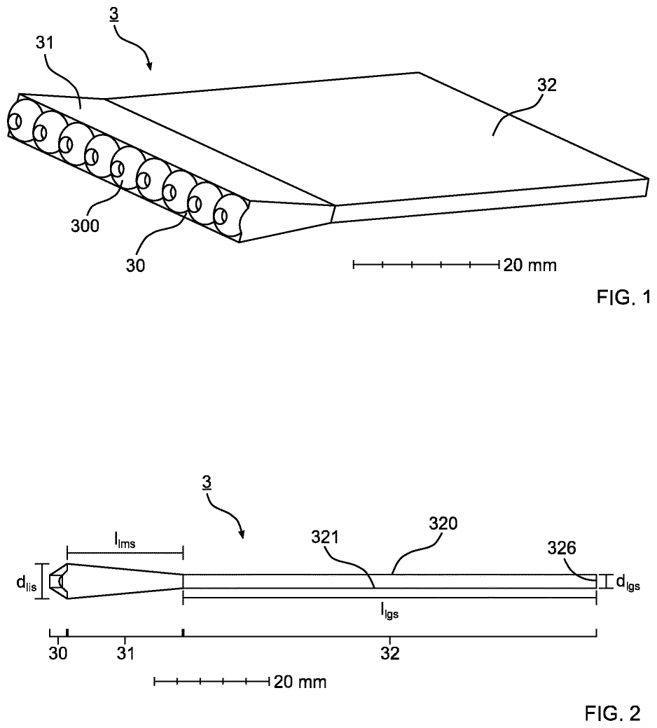

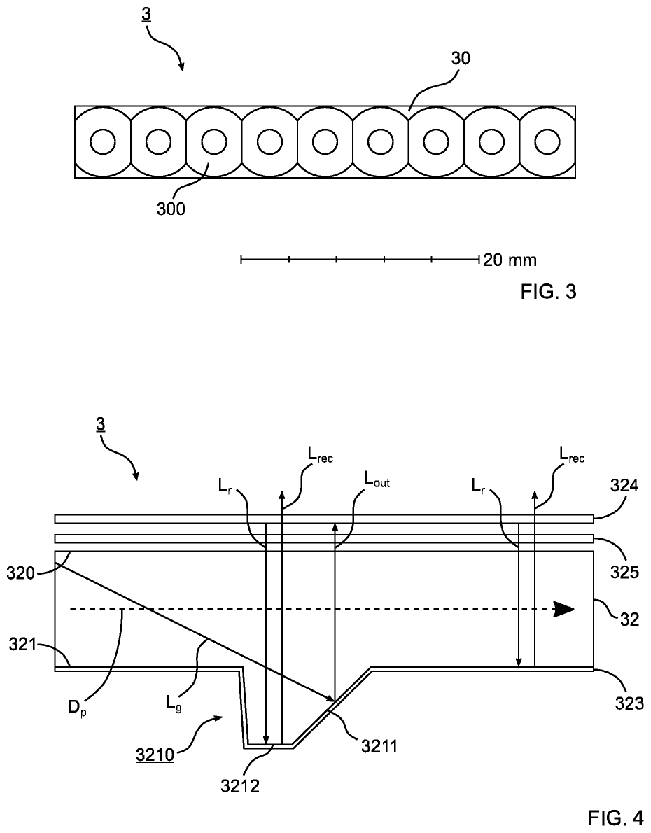

FIG. 1 shows a perspective view of a light guide 3 according to the invention. A side view of the light guide 3 is depicted in FIG. 2. The light guide 3 comprises a light incoupling section 30, a tapered light mixing section 31, and a light guiding section 32. The light incoupling section 30 has a first thickness dis and comprises an array of total internal reflection collimators 300. A front view of the light incoupling section 30 and the array of total internal reflection collimators 300 is shown in FIG. 3. The light guiding section 32 has a length l_{lgs} and a second thickness digs smaller than the first thickness dₗᵢₛ. The tapered light mixing section 31 has a length lₗₘₛ and connects the light incoupling section 30 and the light guiding section 32. The light guiding section 32 has a top surface 320 and a bottom surface 321 and is configured to couple out light guided within the light guiding section 32 through the top surface 320. An end face 326 of the light guiding section 32 is advantageously designed to reflect light guided within the light guiding section 32 that reaches the end face 326. While in FIG. 1 and FIG. 2 there is only one light incoupling section 30 and one tapered light mixing section 31, light incoupling sections 30 and tapered light mixing sections 31 may likewise be arranged at two sides of the light guiding section 32.

FIG. 4 illustrates light paths and outcoupling structures 3210 of the light guide 3 of FIG. 1. Light L_{g} guided within the light guiding section 32 of the light guide 3 travels along a propagation direction Dₚ. The outcoupling structures 3210 are arranged in a bottom surface 321 of the light guiding section 32 of the light guide 3. In this example, a reflective coating 323 is arranged on the bottom surface 321 to reduce light losses through the bottom surface 321. The outcoupling structures 3210 have regions 3211 that are inclined relative to the bottom surface 321. The inclined regions 3211 are configured to direct a fraction of the light L_{g} guided within the light guiding section 32 towards the top surface 320 of the light guiding section 32, where it at least partially leaves the light guiding section 32 and forms outcoupled light Lₒᵤₜ.

The outcoupling structures 3210 further have regions 3212 that are parallel to the bottom surface 321. The light guide 3 is designed to implement so-called polarization recycling. A reflective polarizer 324 above the light guiding section 32 reflects light Lᵣ with a polarization state that would otherwise be absorbed by the display panel that is illuminated using the light guide 3. With the help of a retardation film 325, the polarization state of the reflected light Lᵣ is transformed into the usable polarization state upon a retroreflection at the bottom surface 321. The resulting recycled light L_{rec} is now able to pass through the reflective polarizer 324.

A length and a tapering of the tapered light mixing section of the light guide 3 are designed such that in conjunction with the outcoupling structures 3210, the light Lₒᵤₜ coupled out of the light guiding section 32 has a narrow angular distribution. A density of the outcoupling structures 3210 along the propagation direction Dₚ is advantageously designed such that the light Lₒᵤₜ coupled out of the light guiding section 32 has an essentially constant brightness distribution over the whole length of the light guiding section 32.

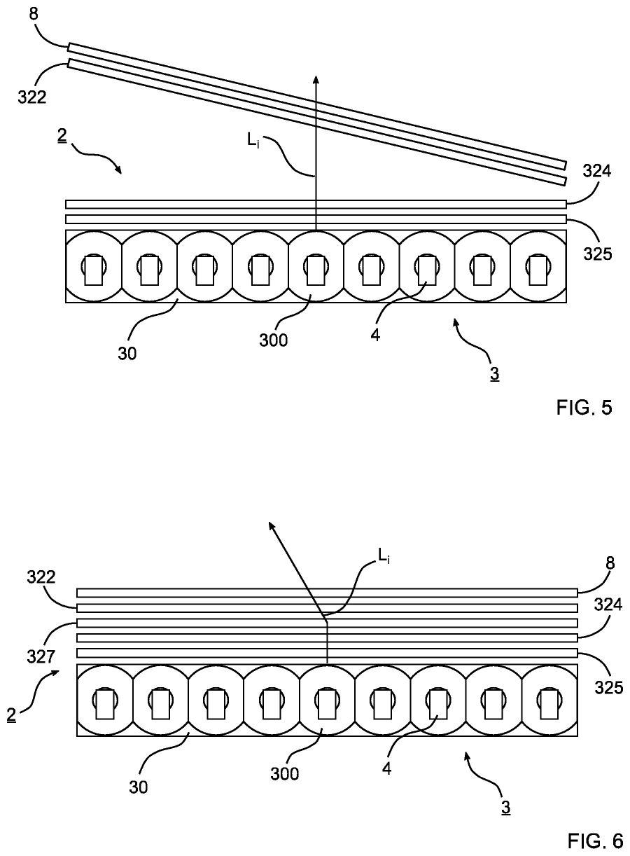

FIG. 5 shows a front view of a backlight unit 2 according to a first embodiment, which uses a light guide 3 according to the invention. Depicted is the light incoupling section 30 with the array of total internal reflection collimators 300. Also depicted are the light sources 4 located in front of the total internal reflection collimators 300. Arranged on the top surface of the light guiding section of the light guide 3 are a retardation film 325 and a reflective polarizer 324 for polarization recycling. For better visualization, the retardation film 325 and the reflective polarizer 324 are shown as separate, spaced apart layers. In practice, they may be stacked on the top surface of the light guiding section. Light coupled out of the light guiding section and passing through the reflective polarizer 324 serves as illumination light Lᵢ. The illumination light Lᵢ passes a diffuser film 322 arranged before a display panel 8 to be illuminated. The diffuser film 322 can be used, for example, to further improve the homogeneity of the illumination light Lᵢ and to modify the angular light distribution. The diffuser film 322 may additionally form a Fresnel lens. In this embodiment, the display panel 8 and the diffuser film 322 are arranged at an angle relative to the top surface of the light guiding section of the light guide 3. This is particularly useful if the backlight unit 2 is used in a head-up display. To suppress solar reflections into the eyebox of a head-up display, the display panel 8 is tilted so that incident light is deflected towards a side wall of the head-up display. However, the light from a picture generating unit of the head-up display must be emitted along the viewing direction. Therefore, it does not leave the display panel 8 vertically, but at an angle.

FIG. 6 shows a front view of a backlight unit 2 according to a second embodiment, which uses a light guide 3 according to the invention. The embodiment corresponds largely to the embodiment of FIG. 5. However, in this embodiment the display panel 8 and the diffuser film 322 are arranged parallel to the top surface of the light guiding section of the light guide 3. In this example, an additional prism film 327 is arranged on the reflective polarizer 324 for changing the direction of the illumination light Lᵢ. The prism film 327 is optional and may likewise be omitted. In this case, the viewing direction is perpendicular to the display panel 8. As before, the various optical layers 322, 324, 325, 327 are shown as separate layers. In practice, they may be stacked on the top surface of the light guiding section.

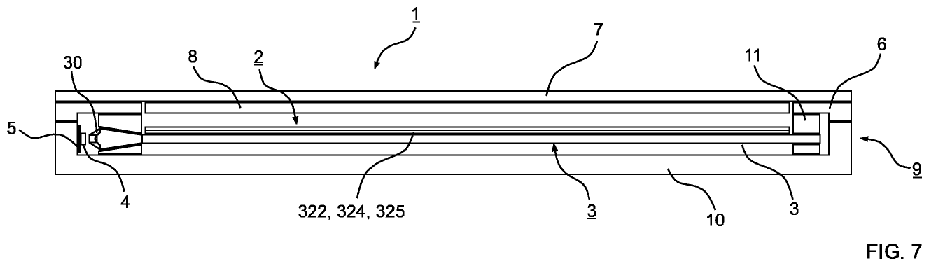

FIG. 7 shows a cut through a display device 1 comprising a backlight unit 2 with a light guide 3 according to the invention. The display device 1 comprises a housing 9 with a back plate 10. The housing 9 is sealed by a cover glass 7. In this example, the cover glass 7 is glued to a fixing element 6 of the housing 9. A display panel 8 is bonded to the cover glass 7 and illuminated by the backlight unit 2. The backlight unit 2 comprises a light guide 3 according to the invention. An array of light sources 4 is mounted on a sidewall of the back plate 10. The light sources 4 are mounted on a circuit board 5 adjacent to the light guide 3 in such way that they emit light towards the light incoupling section 30 of the light guide 3. For example, the light sources 4 may be front-emitting diodes, i.e., light-emitting diodes that emit from their top surface. Cushion tape 11 is arranged between the fixing element 6 of the housing 9 and the light guide 3 in order to prevent a movement of the light guide 3 in a direction perpendicular to the display panel 8. Movement of the light guide 3 in a direction parallel to the display panel 8 may prevented by projections of the back plate 10, which are not shown in FIG. 7.

### REFERENCE NUMERALS

1 Display device
2 Backlight unit
3 Light guide
30 Light incoupling section
300 Total internal reflection collimator
31 Tapered light mixing section
32 Light guiding section
320 Top surface of light guiding section
321 Bottom surface of light guiding section
3210 Outcoupling structure
3211 Inclined region
3212 Parallel region
322 Diffuser film
323 Reflective coating
324 Reflective polarizer
325 Retardation film
326 End face
327 Prism film
4 Light source
5 Circuit board
6 Fixing element
7 Cover glass
8 Display panel
9 Housing
Back plate
11 Cushion tape
d_{lgs} Thickness of light guiding section
dₗᵢₛ Thickness of light incoupling section
Dₚ Propagation direction
Lᵢ Illumination light
L_{g} Light guided in light guiding section
lₗₘₛ Length of light mixing section
Lₒᵤₜ Light coupled out of light guiding section
Lᵣ Reflected light
L_{rec} Recycled light

1. A light guide for a backlight unit, comprising:
at least one light incoupling section having a first thickness, the at least one light incoupling section comprising an array of total internal reflection collimators;
a light guiding section having a second thickness smaller than the first thickness, the light guiding section having a top surface and a bottom surface, wherein the light guiding section is configured to couple out light guided within the light guiding section through the top surface; and
at least one tapered light mixing section connecting the at least one light incoupling section and the light guiding section.

2. The light guide according to claim 1, wherein the bottom surface of the light guiding section comprises outcoupling structures, wherein the outcoupling structures have regions that are inclined relative to the bottom surface of the light guiding section and are configured to direct a fraction of the light guided within the light guiding section towards the top surface of the light guiding section.

3. The light guide according to claim 2, wherein a length and a tapering of the tapered light mixing section are designed such that in conjunction with the outcoupling structures the light coupled out of the light guiding section has a narrow angular distribution.

4. The light guide according to claim 2, wherein a density of the outcoupling structures along a propagation direction of the light guided within the light guiding section is designed such that the light coupled out of the light guiding section has an essentially constant brightness distribution over the whole length of the light guiding section.

5. The light guide according to claim 1, further comprising a diffuser film arranged on or above the top surface of the light guiding section.

6. The light guide according to claim 1, further comprising a reflective coating arranged on the bottom surface of the light guiding section.

7. The light guide according to claim 1, further comprising a reflective polarizer arranged on the top surface of the light guiding section.

8. The light guide according to claim 7, further comprising a retardation film arranged between the top surface of the light guiding section and the reflective polarizer.

9. The light guide according to claim 7, wherein the light guiding section consists of a birefringent material.

10. The light guide according to claim 7, wherein the outcoupling structures have regions that are parallel to the bottom surface of the light guiding section.

11. The light guide according to claim 1, wherein an end face of the light guiding section is designed to reflect light guided within the light guiding section that reaches the end face.

12. The light guide according to claim 1, wherein light incoupling sections and tapered light mixing sections are arranged at two sides of the light guiding section.

13. A backlight unit comprising a light guide according to claim 1, the backlight unit further comprising at least one array of light sources, the light sources being configured to emit light towards the total internal reflection collimators.

14. A display device comprising the backlight unit of claim 13, the display device further comprising a display panel configured to be illuminated by light provided by the backlight unit.

15. The display device according to claim 14, wherein the display device is configured to be used in a head-up display or to provide a switchable privacy functionality.

16. The display device according to claim 14, further comprising a prism film configured to change a direction of illumination light originating from the backlight unit.
